(19) United States
(12) Patent Application Publication
(10) Pub. No.: US 2026/0087712 A1
(43) Pub. Date: Mar. 26, 2026

(54) AI-BASED TECHNIQUES FOR GENERATING INTERACTIVE, ANIMATED VIDEO

(71) Applicant: Advanced Micro Devices, Inc., Santa Clara, CA (US)

(72) Inventors: Karthik Mohan Kumar, Santa Clara, CA (US); Pedro Antonio Peña, Orlando, FL (US)

(73) Assignee: Advanced Micro Devices, Inc., Santa Clara, CA (US)

(21) Appl. No.: 18/895,297

(22) Filed: Sep. 24, 2024

(51) Int. Cl. G06T 13/40

(52) U.S. Cl. CPC G06T 13/40

(57) ABSTRACT

A video animation system can include at least one processor and at least one computer-readable storage medium having encoded thereon instructions that, when executed by the at least one processor, cause the at least one processor to perform operations. The operations can include generating a first frame of a video including a first avatar wherein the first avatar has a first gaze direction and/or a first pose; generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and outputting the first and second frames. Various other methods and systems are also disclosed.

### BACKGROUND

A wide variety of computer applications can provide video of scenes in which animated avatars interact (e.g., converse) with each other. Some examples of such applications include video games, content creation engines for movies and shows, virtual reality (VR) applications, augmented reality (AR) applications, video-conferencing software, metaverse applications, etc. Such avatars can represent human users, programmed characters, artificial agents, digital assistants, etc. In some cases, the computer applications can automatically generate, in real-time, animated three-dimensional (3D) videos in which avatars interact.

### BRIEF DESCRIPTION OF THE FIGURES

The accompanying drawings illustrate a number of example implementations and are a part of the specification. Together with the following description, these drawings demonstrate and explain various principles of the present disclosure.

FIG. 1 is a block diagram of an example system for video animation.

FIG. 2A is a block diagram of an example of a model of a scene.

FIG. 2B is a block diagram of an example of an animator.

FIG. 3 is a block diagram of an example of a character animator.

FIG. 4A is a block diagram of another example of a character animator.

FIG. 4B is a block diagram of yet another example of a character animator.

FIG. 5 is a flow diagram of an example method for video animation.

FIG. 6 is a block diagram of another example of a video animation system.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to artificial intelligence (AI)-based techniques for generating interactive, animated video. In some examples, animated video can be generated by recording live actors, displaying photographs of a scene in sequence (e.g., stop-motion animation), or displaying hand-drawn images or computer-generated images in sequence. However, these techniques produce video that is either non-interactive (meaning that the end user cannot provide input to control the actions of any of the characters depicted in the video) or supports only very limited interaction (e.g., the end user can provide input to control which pre-recorded video segment is presented next, but otherwise cannot control the actions of the characters depicted in the video).

In other examples, interactive, animated video can be generated via heuristic-driven animation of computer-generated content. For example, with some video games, the user can control some movements and actions of a character, and the video game software uses heuristics to attempt to infer related animations of the character's avatar that are consistent with the user's inputs (e.g., as the user controls where the character walks or what the character says, the video game software uses the heuristics to attempt to infer where the avatar's gaze should be directed, how the avatar's head and body should be posed, etc.). However, such heuristic-driven animations are generally unnatural and unrealistic. In many cases, the gaze direction of an avatar animated with heuristic-driven animation is inconsistent with a human user's expectations, given the human user's understanding of the scene. Likewise, the pose of an avatar's head or body is often inconsistent with a human user's expectations. For example, when moving away from a dangerous enemy, an avatar animated with heuristic-driven animation may turn its back on the enemy and gaze in the direction the avatar is moving, rather than backing away from the enemy while maintaining a defensive posture and continuing to gaze at the enemy. As another example, when an avatar animated with heuristic-driven animation converses with another character, the avatar may continue gazing at the speaking character even when the speaking character's words or gestures draw the focus of the scene (or the human user) to an object or a different character, rather than gazing at least briefly or intermittently at the object/character that is the focus of the conversation. In addition, when an avatar is animated with heuristic-driven animation, the avatar's gaze direction and pose are often inconsistent with each other (e.g., the avatar's head and body are oriented in one direction, while the avatar's gaze is oriented in another direction that is unnatural in the context of the avatar's pose).

The inventors have recognized and appreciated that data-driven animation techniques can be used to improve computer-based technologies for generating video content (e.g., interactive, animated, three-dimensional (3D) video content). In some examples, such data-driven techniques are used to control the gaze direction and/or pose of one or more avatars in an interactive, animated video in real time. In some examples, data-driven animation is performed using an artificial intelligence (AI) model. For example, an AI model can control the gaze direction and/or pose of one or more avatars based on environmental features of the scene being depicted in the video. Such environmental features can include physical features of the scene (e.g., locations of objects, locations of characters, locations of face and body landmarks of characters, etc.), emotional features of the scene (e.g., emotional context of a storyline, characters'states of mind, emotional context of a conversation taking place in the scene, etc.), and/or social features of the scene (e.g., social or hierarchical relationships between characters, social status of characters, applicable cultural norms, etc.). By controlling an avatar's gaze direction and pose based on the same environmental features, inconsistencies between gaze and pose can be reduced or eliminated. Furthermore, in some examples, the AI model also controls the avatars'gaze direction and pose based on prior trajectories of the avatars'gaze direction and pose or prior predictions of the future trajectories of the avatars'gaze direction and pose, which can help avoid unnaturally sudden changes in gaze direction and pose.

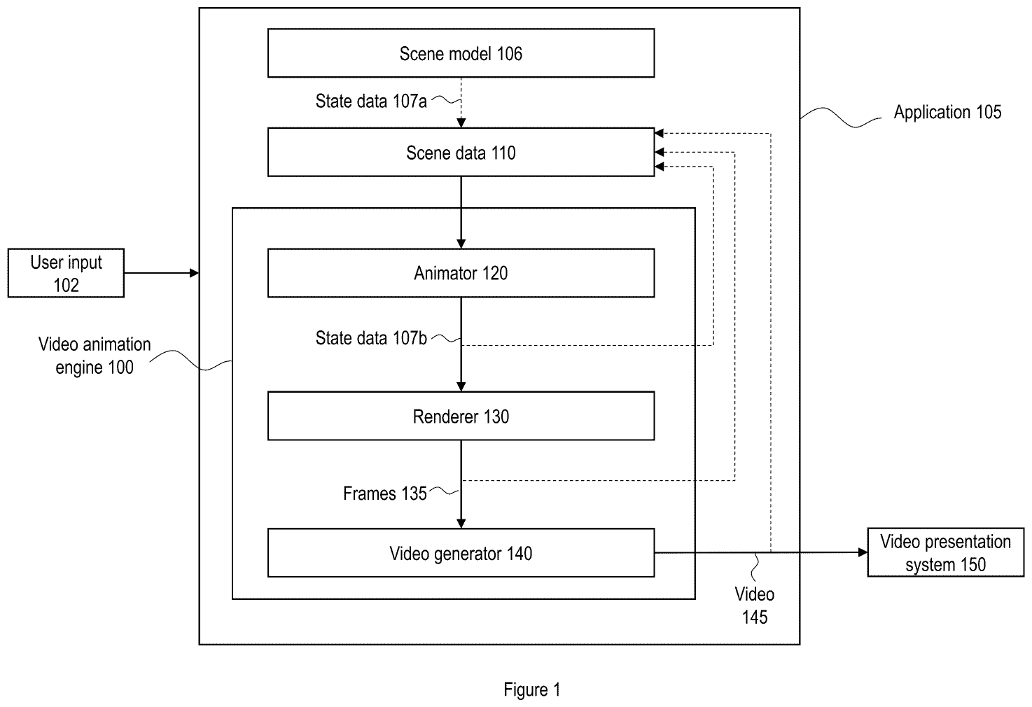

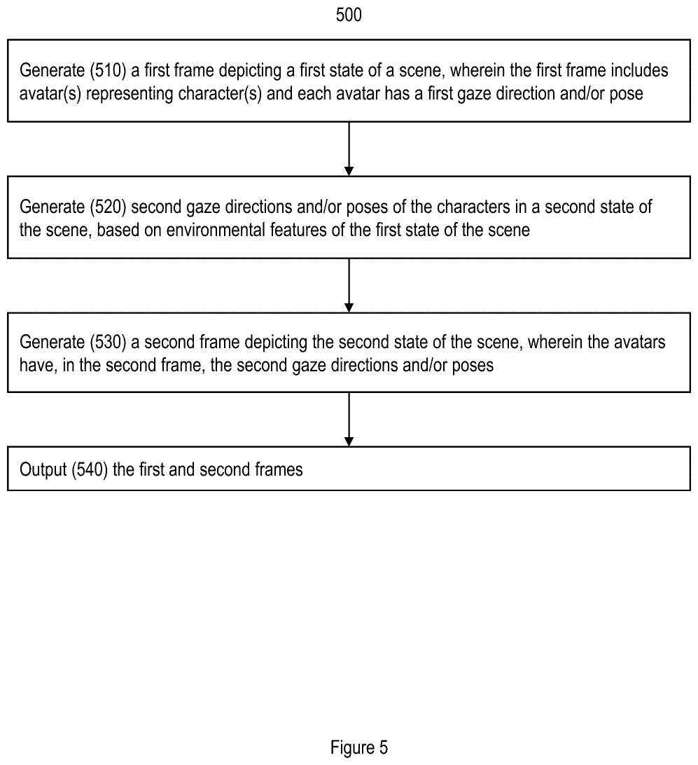

This disclosure provides, with reference to FIGS. 1-4 and 6, detailed descriptions of example systems for interactive video animation. Detailed descriptions of corresponding computer-implemented methods are provided in connection with FIG. 5.

In some aspects, the techniques described herein relate to a video animation system including at least one processor; and at least one computer-readable storage medium having encoded thereon instructions that, when executed by the at least one processor, cause the at least one processor to perform operations including: generating a first frame of a video including a first avatar wherein the first avatar has a first gaze direction and/or a first pose; generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and outputting the first and second frames.

In some aspects, the techniques described herein relate to a system, wherein the at least one processor includes at least one graphics processing unit (GPU).

In some aspects, the techniques described herein relate to a system, wherein the video includes a sequence of frames depicting a sequence of respective states of a scene, the scene including one or more characters, the sequence of frames including one or more respective avatars of the one or more characters.

In some aspects, the techniques described herein relate to a system, wherein the sequence of frames includes the first frame and the second frame, wherein the first frame depicts a first state of the sequence of states of the scene, and wherein the second frame depicts a second state of the sequence of states of the scene.

In some aspects, the techniques described herein relate to a system, wherein the operations further include generating the video, and wherein generating the video includes: the generating the first frame; generating, using at least one model, character data indicating the second gaze direction and/or the second pose of the first character in the second state of the scene, the generating the character data being based on the plurality of environmental features of the first frame; and the generating the second frame, wherein the plurality of environmental features of the first frame correspond to the first state of the scene.

In some aspects, the techniques described herein relate to a system, wherein the at least one processor includes a first processor configured to perform the generating the first frame and the generating the second frame, and a second processor configured to perform the generating the character data.

In some aspects, the techniques described herein relate to a system, wherein the generating the character data using the at least one model is further based on the first gaze direction and/or the first pose of the first avatar in the first frame, and wherein the at least one model includes at least one character animation model.

In some aspects, the techniques described herein relate to a system, wherein the generating the character data using the at least one model is further based on one or more predicted gaze directions and/or one or more predicted poses of the first avatar for one or more frames subsequent to the second frame, and wherein the at least one model includes at least one character animation model.

In some aspects, the techniques described herein relate to a system, wherein the plurality of environmental features of the first frame include one or more physical environmental features of the first state of the scene, and wherein the one or more physical environmental features of the first state of the scene include one or more attributes of the one or more characters in the first state of the scene, wherein the one or more attributes of a particular character of the one or more characters include a location of the particular character, a location of a facial landmark or body landmark of the particular character, a gaze direction of the particular character, and/or a pose of the particular character.

In some aspects, the techniques described herein relate to a system, wherein the one or more emotional environmental features of the first frame include one or more emotional states of the one or more characters, a mood of a conversation between two or more of the characters, and/or an emotional context associated with the scene.

In some aspects, the techniques described herein relate to a system, wherein the one or more social features of the first frame include one or more social statuses of the one or more characters, one or more social or hierarchical relationships between or among the one or more characters, and/or a cultural context associated with the one or more characters.

In some aspects, the techniques described herein relate to a system, wherein the video depicts at least a portion of a video game, movie, show, videoconference, virtual reality (VR) application, augmented reality (AR) application, metaverse, or digital assistant.

In some aspects, the techniques described herein relate to a video animation method, including: generating, by at least one processor, a first frame of a video including a first avatar wherein the first avatar has a first gaze direction and/or a first pose; generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and outputting the first and second frames.

In some aspects, the techniques described herein relate to a video animation method, wherein the video includes a sequence of frames depicting a sequence of respective states of a scene, the scene including one or more characters, the sequence of frames including one or more respective avatars of the one or more characters, wherein the sequence of frames includes the first frame and the second frame, wherein the first and second frames depict first and second states of the sequence of states of the scene, respectively.

In some aspects, the techniques described herein relate to a video animation method, wherein the plurality of environmental features of the first frame include at least two of a physical environmental feature of the first state of the scene, an emotional environmental feature of the first state of the scene, or a social environmental feature of the first state of the scene.

In some aspects, the techniques described herein relate to a video animation method, wherein the video depicts at least a portion of a video game, movie, show, videoconference, virtual reality (VR) application, augmented reality (AR) application, metaverse, or digital assistant.

In some aspects, the techniques described herein relate to a video animation method, further including generating character data indicating the second gaze direction and/or the second pose of the first avatar in the second frame, the generating the character data being based on a plurality of environmental features of the first frame.

In some aspects, the techniques described herein relate to a video animation method, wherein the first avatar has, in the first frame, a first facial expression, wherein the character data further indicate a second facial expression of the character, and wherein the first avatar has, in the second frame, the second facial expression.

In some aspects, the techniques described herein relate to a video animation method, wherein the generating the character data is further based on the first gaze direction and/or the first pose of the first avatar in the first frame.

In some aspects, the techniques described herein relate to a video animation method, wherein the generating the character data is further based on one or more predicted gaze directions and/or one or more predicted poses of the first avatar for one or more frames subsequent to the second frame.

In some aspects, the techniques described herein relate to a video animation method, wherein the plurality of environmental features of the first frame include one or more physical environmental features of the first state of the scene, and wherein the one or more physical environmental features of the first state of the scene include one or more attributes of one or more objects, entities, and/or settings in the first state of the scene.

In some aspects, the techniques described herein relate to a video animation method, wherein the plurality of environmental features of the first frame include one or more physical environmental features of the first state of the scene, and wherein the one or more physical environmental features of the first state of the scene include one or more attributes of the one or more characters in the first state of the scene, wherein the one or more attributes of a particular character of the one or more characters include a location of the particular character, a location of a facial landmark or body landmark of the particular character, a gaze direction of the particular character, and/or a pose of the particular character.

In some aspects, the techniques described herein relate to a video animation method, wherein the one or more emotional environmental features of the first frame include one or more emotional states of the one or more characters, a mood of a conversation between two or more of the characters, and/or an emotional context associated with the scene.

In some aspects, the techniques described herein relate to a video animation method, wherein the one or more social features of the first frame include one or more social statuses of the one or more characters, one or more social or hierarchical relationships between or among the one or more characters, and/or a cultural context associated with the one or more characters.

In some aspects, the techniques described herein relate to at least one computer-readable storage medium encoded with computer-executable instructions that, when executed by at least one computer, cause the at least one computer to perform operations including: generating a first frame a video including a first avatar wherein the first avatar has a first gaze direction and/or a first pose; generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and outputting the first and second frames.

FIG. 1 is a block diagram of an example video animation engine 100. In some examples, the video animation engine 100 can animate a scene, render images of the animated scene, and generate video that incorporates the rendered images. In some examples, the video depicts a scene in which avatars interact (e.g., converse) with each other, objects in the scene, or other aspects of their environment. Such avatars can represent human users, programmed characters, artificial agents, digital assistants, etc. In some examples, the video animation engine can automatically generate, in real-time, animated two-dimensional (2D) or three-dimensional (3D) videos in which such avatars interact. In some examples, the video animation engine can automatically generate a 3D animation and render the 3D animation into a 2D cinematic video. The video animation engine 100 can be a component of a video-based application 105, e.g., a video game, video content creation engine (e.g., for movies or shows), virtual reality application (VR application), augmented reality application (AR application), video-conferencing application, metaverse application, etc.

In the example of FIG. 1, the video animation engine 100 includes an animator 120, a renderer 130, and a video generator 140. These components are described in further detail below. In some examples, at least some of the animation generated by the video animation engine 100 is generated in response to user input 102. The user input 102, when processed by the application 105 or video animation engine 100, can cause any suitable change in the state of any character, object, or entity associated with (e.g., depicted in) the animated scene, including (without limitation) any suitable change in the position (e.g., location, orientation, posture, etc.) or motion (e.g., speed, direction, etc.) of any character or part thereof (e.g., body part), any object or part thereof, or any entity or part thereof.

Any suitable user input can be provided to the video animation engine 100 or application 105 including, without limitation, audio input (e.g., spoken commands directed to a natural language interface of the engine 100 or application 105, spoken words directed to other users of the application 105 (e.g., a VR, AR, or video-conferencing application), etc.), text input (e.g., commands directed to the engine 100 or application 105, messages directed to other users of the application 105, etc.), positional input (e.g., input that controls the location, orientation, or posture (e.g., standing, crouching, sitting, laying down, etc.) of an avatar, object, or entity associated with the scene), motional input (e.g., input that controls a motion (e.g., walking, running, jumping, diving, etc.) of an avatar, object, or entity associated with the scene), activity input (e.g., input that controls an activity (e.g., talking, using a weapon, throwing a ball, casting a spell, etc.) of an avatar, object, or entity associated with the scene, etc. The user input 102 can be provided using any suitable input device including, without limitation, a microphone, video camera, keyboard, mouse, touchpad, touchscreen, controller (e.g., video game controller), etc.

As noted above, the video animation engine 100 can animate a scene. The scene can include one or more characters, objects, entities, settings, and/or any other suitable parts of an environment generated or managed by the application 105. Characters can include user-controlled characters, non-playable characters (e.g., programmed characters controlled by heuristics or deterministic programs), artificial agents (e.g., characters controlled by AI models), etc. User-controlled characters can include characters that represent the user (e.g., a digital representation of the user's persona in a virtual environment) and characters that represent other personas (e.g., a digital representation of a fictional persona). Objects can include non-character items that users or characters can perceive (e.g., visually) and manipulate. In some examples, characters can move, carry, transform, consume, or otherwise manipulate an object. Entities can include items that are not perceivable by the characters (e.g., cameras). Settings can include aspects of the scene that users or characters can perceive (e.g., visually) but not manipulate. In some examples, characters can interact with a setting (e.g., by touching, standing on, climbing, or moving along or through the setting) without altering attributes of the setting.

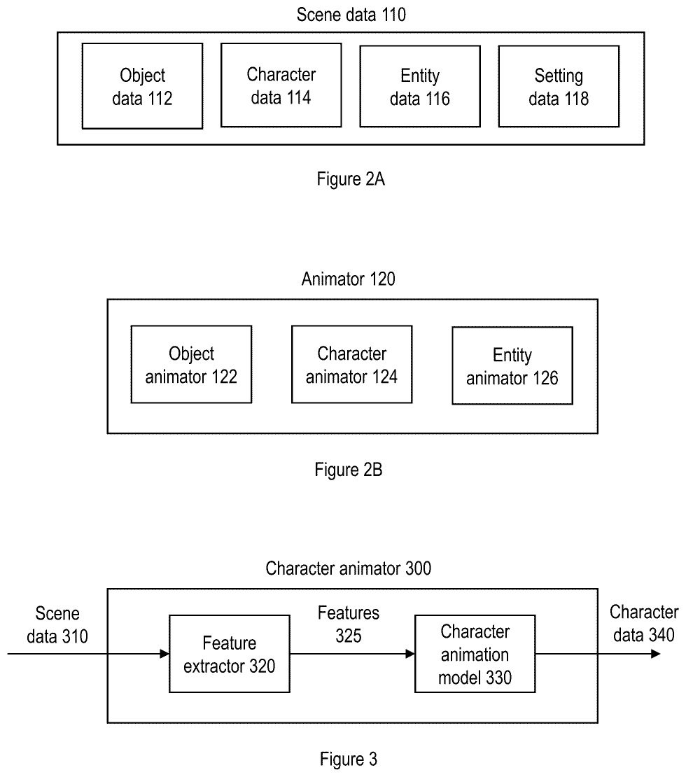

The video animation engine 100 can animate a scene of the application 105 based on scene data 110 indicating attributes of the scene. Referring to FIG. 2A, the scene data 110 can include object data 112 indicating attributes of the scene's objects, character data 114 indicating attributes of the scene's characters, entity data 116 indicating attributes of the scene's entities, and/or setting data 118 indicating attributes of the scene's settings. In some examples, the scene data 110 can include user input data characterizing the user input 102.

In some examples, the attributes indicated by the character data 114 can include a character's physical attributes, for example, the character's gaze direction (e.g., the direction in which the character's eyes are looking, relative to the character's face); the character's pose (e.g., the orientation of the character's head, body, and/or body parts, the character's posture, etc.), the character's facial expression, the character's location; locations and shapes of the character's facial landmarks (e.g., eyes, mouth, ears, forehead, etc.); locations and shapes of the character's body landmarks, which can include body parts (e.g., feet, legs, torso, hands, arms, fingers, neck, head, etc.) and joints (e.g., ankles, knees, hips, wrists, elbows, shoulders, etc.); the character's motion (e.g., the character's velocity, the velocities and joint angles of the character's body parts, etc.); the character's height, size, musculature, hair color and style, eye color, skin tone, etc.; the character's strength, speed, stamina, etc.; or any other suitable physical attribute. In some examples, one or more physical attributes of a character can be visually represented by the character's avatar.

In some examples, the attributes indicated by the character data 114 can include a character's social attributes, for example, a social status (e.g., the character's rank, position, class, or degree of power or value within a group), a health status (e.g., injured, ill, healthy, etc.), a cultural context (e.g., cultural practices of a culture associated with the character, such as a culture in which the character lives or previously lived), social or hierarchical relationships between the character and other characters, etc. In some examples, a character's social attributes can include an inventory of any items carried by or otherwise possessed by the character, an inventory of the character's capabilities (e.g., skills the character has acquired, acts the character can perform, etc.), etc.

In some examples, the attributes indicated by the character data 114 can include a character's emotional attributes, for example, an emotional state, an emotional response (e.g., a tendency to exhibit a particular emotional state in response to a particular event, object, character, or setting), etc.

In some examples, the attributes indicated by the object data 112 can include an object's physical attributes, for example, the object's location, size, and overall shape; locations, shapes, sizes, and colors of portions of the object; the object's motion (e.g., the object's velocity, the velocities and joint angles of the object's parts, etc.); effects of the object on the physical attributes of a character who possesses, sees, or is located near the object; etc. In some examples, the attributes indicated by the object data 112 can include an object's emotional and/or social attributes (e.g., effects of the object on a character's emotional and/or social attributes when the character possesses, sees, or is located near the object, etc.).

In some examples, the attributes indicated by the entity data 116 can include an entity's physical attributes. As just one example, if the entity is a camera, the entity's physical attributes can include the camera's location, orientation, zoom level, velocity, etc.

In some examples, the attributes indicated by the setting data 118 can include a setting's physical attributes, for example, the setting's location, size, and contour; locations, shapes, sizes, and colors of portions of the setting; effects of the setting on a character's physical attributes when the character is located in or near the setting; etc. In some examples, the attributes indicated by the setting data 118 can include a setting's emotional and/or social attributes (e.g., effects of the setting on a character's emotional and/or social attributes when the character is located in or near the setting, etc.).

In some examples, attributes indicated by the scene data 110 can include one or more attributes of the scene that are not attributes of characters, objects, entities, or settings associated with the scene. For example, such attributes can include the mood of a conversation between or among characters, an emotional context of the scene (e.g., an emotional state elicited by an event or storyline depicted in the scene), etc.

In some examples, the scene data 110 includes outputs generated by a scene model 106, which indicate attributes of the scene. In some examples, the scene model 106 includes models of the scene's objects (object models), characters (character models), entities (entity models), settings (setting models), etc. In some examples, a character model indicates one or more attributes of a character included in or associated with a scene. In some examples, an object model indicates one or more attributes of an object included in or associated with a scene. In some examples, an entity model indicates one or more attributes of an entity included in or associated with a scene. In some examples, a setting model indicates one or more attributes of a setting included in or associated with a scene. In some examples, the scene model 106 indicates one or more attributes of the scene that are not attributes of characters, objects, entities, or settings.

In addition to or as an alternative to outputs of the scene model 106, the scene data 110 can include the frames 135 generated by the renderer 130 and/or the video 145 generated by the video generator 140. The frames 135 and/or the video 145 can be provided by the video animation engine 100 as streams, which can be fed back to the input of the video animation engine 100 and incorporated into the scene data 110 in real time. Including either the frames 135 or the video 145 in scene data 110 can be advantageous because the animator 120 can process the raw image data in the frames 135 or video 145 to infer attributes of the characters or objects depicted in the scene and attributes of the scene's physical, emotional, and social environments. For example, the raw image data can convey which characters and objects are depicted in the scene, where those characters and objects are located, where facial and body landmarks of the characters are located, what the characters are doing, what the characters can see, etc. In some examples, including the video 145 in the scene data 110 is advantageous because the video can include audio and/or text data (e.g., one or more audio tracks and/or subtitles) synchronized with the video images (frames), and the animator 120 can process the audio and/or text data (e.g., soundtrack, audible conversations between characters, other audible noises, etc.) to infer attributes of the scene's emotional environment. For example, the audio and/or text data can convey the topic and mood of a conversation between or among characters, the mood of a musical soundtrack, etc. In some examples, including the video 145 in the scene data 110 is advantageous because the video can include motion data, and the animator 120 can process the motion data to infer or characterize the movements occurring in the scene (e.g., velocities of characters, characters'body parts, and objects; joint angles characterizing body motion; etc.).

In addition or as an alternative to including the frames 135 or video 145, the scene data can include “raw video data” extracted from the frames 135 or video 145. Such raw video data can include the raw image data of the frames or video, the audio and/or text data of the video, the motion data of the video, etc.

In general, using frames 135, video 145, and/or raw video data rather than outputs of a scene model 106 as the scene data 110 can facilitate integration of the animator 120 with existing animation pipelines because existing animation pipelines generally provide outside access to frames/video/raw video data, but often do not provide outside access to scene models or their outputs. Thus, an animator 120 that uses frames/video/raw video data for scene data 110 can easily “plug in” to an existing animation pipeline, whereas an animator 120 that uses outputs of scene models for scene data 110 can be dependent on tight integration with the existing animation pipeline through an application programming interface (API) or another suitable interface. On the other hand, using outputs of a scene model rather than frames/video/raw video data as scene data 110 can improve the computational efficiency and reduce the size or complexity of the animator 120, because the animator 120 can obtain many attributes of the scene directly from the outputs of the scene model, rather than relying on data-driven algorithms and models to infer those same attributes from the frames/video/raw video data.

In some examples, the scene data 110 can include both frames/video/raw video data and at least some outputs of the application's scene model 106. This approach can facilitate relatively loose integration of the animator 120 into existing animation pipelines, while also providing direct access to scene model outputs that could otherwise be difficult to infer.

When the animator 120 is integrated with an existing animation pipeline, integration issues can also arise with respect to the output of the animator 120. In some examples, the animator 120 generates one or more character attributes (e.g., gaze direction, pose, facial expression, etc.) that are also generated by the scene model 106 of the existing animation pipeline. In some examples, the animation engine 100 overrides (e.g., adjusts or corrects) the attribute values generated by the existing animation pipeline's scene model 106 with the corresponding attribute values generated by the animator 120. Such overriding can be carried out using an API or any other suitable interface.

Some examples have been described in which the animator 120 is loosely integrated with an existing animation pipeline in a video animation engine 100. In other examples, the animator 120 is tightly integrated with other components of the animation pipeline. For example, the animator 120 can be a native component of the animation pipeline, such that the animator 120 has access to the outputs of the scene model 106 and frames/video/raw video data through internal interfaces of the animation pipeline, and the other components of the animation pipeline have access to the outputs of the animator through similar internal interfaces. Both loosely integrated implementations and tightly integrated implementations are within the scope of the present disclosure.

Referring again to FIG. 1, a scene can progress through a sequence of states over a period of time. The state Sₖ of a scene at a time tₖ can include a set of values of the attributes of the scene for the time tₖ, which can be included in or inferred from the scene data 110. In some examples, the values of one or more attributes of a scene (or its components) can vary over time. For example, the location (e.g., coordinates in a frame of reference) of a character can change from a first value (x₁, y₁, z₁) at a first time to a second value (x₂, y₂, z₂) at a second time. Such changes can occur in response to user input 102, the passage of time, events occurring within the scene, and/or any other suitable stimulus.

In some examples, the scene model 106 and the animator 120 animate the scene. Animating the scene can involve generating (e.g., updating) the state Sₖ of the scene for time tₖ (e.g., generating attribute values representing the state Sₖ of the scene for time tₖ) based on one or more states Sₖ₋₁, Sₖ₋₂, . . . , Sₖ₋ₙ of the scene for prior times tₖ₋₁, tₖ₋₂, . . . , tₖ₋ₙ (e.g., based on the attribute values representing states of the scene for times tₖ₋₁, tₖ₋₂, . . . , tₖ₋ₙ). The scene model 106 and animator 120 can generate a state Sₖ of the scene based on any suitable number of prior states of the scene (e.g., 1, 2, or more than 2 prior states). In some examples, the attribute values corresponding to the scene state Sₖ and/or the prior scene states can be included in or inferred from the scene data 110.

In some examples, animating the scene can update the attribute values representing the state of the scene in ways that cause one or more changes in the visual representation of the scene. In some examples, animating the scene can update one or more attribute values representing the state of the scene in ways that are not reflected in any update to the visual representation of the scene.

In the example of FIG. 1, the notation “state data 107a” refers to the attribute values for state Sₖ of the scene as generated by the scene model 106, and the notation “state data 107b” refers to the attribute values for state Sₖ of the scene as generated by the scene model 106 and overridden by the animator 120.

Referring to FIG. 2B, a block diagram of an example of an animator 120 is shown. The animator 120 can include an object animator 122, a character animator 124, an entity animator 126, etc. The object animator 122 can animate the objects in (or associated with) the scene. In some examples, animating an object involves generating (e.g., updating) the state Obj-Sₖ of the object for time tₖ (e.g., generating attribute values representing the state Obj-Sₖ of the object for time tₖ) based on one or more states Sₖ₋₁, Sₖ₋₂, . . . , Sₖ₋ₙ of the scene for times tₖ₋₁, tₖ₋₂, . . . , tₖ₋ₙ (e.g., based on the attribute values of the scene for times tₖ₋₁, tₖ₋₂, . . . , tₖ₋ₙ). Any suitable object animation techniques can be used.

The entity animator 126 can animate the entities in (or associated with) the scene. In some examples, animating an entity involves generating (e.g., updating) the state Ent-Sₖ of the entity for time tₖ (e.g., generating attribute values representing the state Ent-Sₖ of the entity for time tₖ) based on one or more states Sₖ₋₁, Sₖ₋₂, . . . , Sₖ₋ₙ of the scene for times tₖ₋₁, tₖ₋₂, . . . , tₖ₋ₙ (e.g., based on the attribute values of the scene for times tₖ₋₁, tₖ₋₂, . . . , tₖ₋ₙ). Any suitable entity animation techniques can be used.

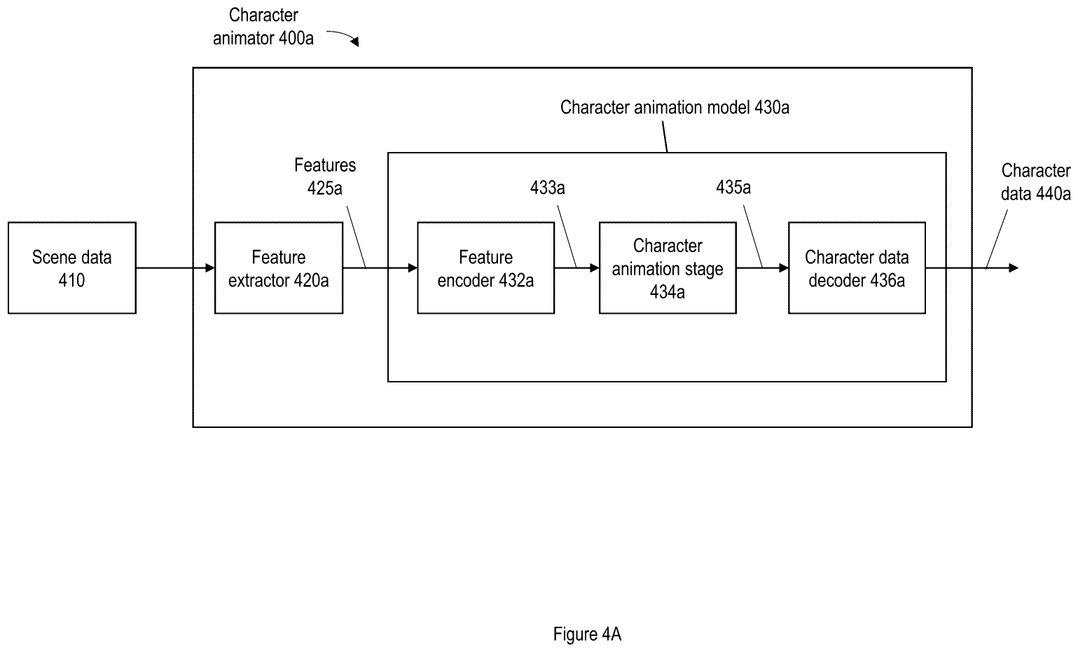

The character animator 124 can animate the characters in (or associated with) the scene. In some examples, animating a character involves generating (e.g., updating) the state Char-Sₖ of the character for time tₖ (e.g., generating attribute values representing the state Char-Sₖ of the character for time tₖ) based on one or more states Sₖ₋₁, Sₖ₋₂, . . . , Sₖ₋ₙ of the scene for times tₖ₋₁, tₖ₋₂, . . . , tₖ₋ₙ (e.g., based on the attribute values of the scene for times tₖ₋₁, tₖ₋₂, . . . , tₖ₋ₙ). Some examples of character animation techniques are described in further detail herein, with reference to FIGS. 3-5.

Referring again to FIG. 1, the renderer 130 renders frames 135 corresponding to states of the scene. In some examples, the renderer 130 renders frame Fₖ corresponding to state Sₖ based on the state data 107b for the scene. In some examples, the rendering of frame Fₖ is further based on frames Fₖ₋₁, Fₖ₋₂, . . . , Fₖ₋ₙ corresponding to one or more prior states Sₖ₋₁, Sₖ₋₂, . . . , Sₖ₋ₙ of the scene. Any suitable image rendering techniques can be used.

Still referring to FIG. 1, the video generator 140 generates video based on the frames provided by the renderer 130. Generating the video can include compressing the frames, encoding the frames, synchronizing the sequence of frames with one or more audio tracks, etc. Any suitable video generation techniques can be used.

In some examples, the renderer 130 renders and outputs frames sequentially, one at a time. In some examples, the renderer 130 renders two or more frames in parallel (e.g., using pipelined and/or parallel processing), and outputs the frames sequentially. In some examples, the renderer 130 can render and/or output two or more frames in parallel.

In some examples, the video animation engine 100 provides the generated video to a video presentation system 150, which can present the video (e.g., display the sequence of frames and play the synchronized audio). The video presentation system 150 can be co-located with the video animation engine or can be located remotely and coupled to the video animation engine by a communication network. The video presentation system 150 can include any components capable of processing and presenting the video. In some examples, the video presentation system includes a video processing device (e.g., computer, CPU, GPU, etc.) capable of processing (e.g., receiving, decoding, decompressing, etc.) the video. In some examples, the video presentation system includes a display device (e.g., computer monitor, television, projector, smartphone screen, tablet screen, laptop screen, etc.) capable of displaying the processed video's frames. In some examples, the video presentation system includes an audio output device (e.g., speakers) capable of playing the synchronized audio. The audio output device can be integrated with or separate from the display device.

Referring to FIG. 3, a block diagram of an example of a character animator 300 (e.g., character animator 124) is shown. In some examples, the character animator 300 includes a feature extractor 320 and a character animation model 330. In some examples, the feature extractor 320 extracts features 325 from scene data 310 and provides those features 325 as inputs to the character animation model 330. The scene data 310 (e.g., scene data 110) can include state data 107a corresponding to state Sₖ of the scene for time tₖ (or any subset thereof), state data 107a and/or state data 107b corresponding to one or more prior states Sₖ₋₁, . . . , Sₖ₋ₙ of the scene for times tₖ₋₁, . . . , t_{k-n,} (or any subset thereof), frames of video 145 corresponding to the prior states of the scene (e.g., frames Fₖ₋₁, . . . , Fₖ₋ₙ), video 145 corresponding to the prior states of the scene, raw video data extracted from the frames 135 and/or video 145, and/or any other suitable data.

In some examples, the feature extractor 320 extracts environmental features of the scene from the scene data 310. The environmental features of the scene can include physical environmental features, emotional environmental features, social environmental features, and/or any other suitable type of environmental features.

The physical environmental features can encode information about the physical environment of the scene. In some examples, the physical environmental features relate to (e.g., include, indicate, and/or are derived from) physical attributes of the scene (e.g., physical attributes of one or more characters, objects, entities, and/or settings associated with the scene). For example, the physical environmental features can relate to locations of characters, locations of facial landmarks or body landmarks of characters, gaze directions of characters, poses of characters, locations of objects, and/or any other suitable physical attributes of the scene.

The emotional environmental features can encode information about the emotional environment of the scene. In some examples, the emotional environmental features relate to (e.g., include, indicate, and/or are derived from) emotional attributes of the scene (e.g., emotional attributes of one or more characters, objects, and/or settings associated with the scene). For example, the emotional environmental features can relate to emotional states of characters, the moods of conversations between or among characters, an emotional context of the scene, and/or any other suitable emotional attributes of the scene.

The social environmental features can encode information about the social environment of the scene. In some examples, the social environmental features relate to (e.g., include, indicate, and/or are derived from) social attributes of the scene (e.g., social attributes of one or more characters, objects, and/or settings associated with the scene). For example, the social environmental features can relate to social statuses of the characters, social or hierarchical relationships between or among the characters, cultural contexts associated with the characters, and/or any other suitable social attributes of the scene.

An example has been described in which the feature extractor 320 extracts environmental features of the scene. In addition to or as an alternative to environmental features, the feature extractor 320 can extract other features from the scene data 310. For example, the feature extractor 320 can extract user input features relating to the user input 102 from the scene data 310, and/or any other suitable features.

The feature extractor 320 can use any suitable feature extraction techniques to extract the features 325. In some examples, the feature extractor 320 can perform data preparation operations, including data labeling (e.g., labeling subsets of the scene data 310 as being related to the physical, social, or emotional attributes of the scene's environment), data reduction (e.g., discarding subsets of the scene data 310 that have little or no relevance to the physical, social, or emotional attributes of the scene's environment), feature generation (e.g., transforming scene data 310, such as raw video data, into structured formats such as vectors), etc. In some examples, the feature extractor 320 is omitted, such that the unaltered scene data 310 are provided to the character animation model 330 as features 325.

Still referring to FIG. 3, the character animation model 330 can animate the characters in (or associated with) a scene based on the features 325 provided by the feature extractor 320. In some examples, the character animation model animates a character by generating character data 340 based on features 325. For example, animating a character can involve generating character data 340 (e.g., state data 107b) indicating the state Char-Sₖ of the character for time tₖ (e.g., generating updated attribute values representing the state Char-Sₖ of the character for time tₖ) based on features 325 corresponding to one or more states Sₖ₋₁, Sₖ₋₂, . . . , Sₖ₋ₙ of the scene for times tₖ₋₁, tₖ₋₂, . . . , tₖ₋ₙ (e.g., features extracted from scene data 310 indicating attribute values of the scene for times tₖ₋₁, tₖ₋₂, . . . , tₖ₋ₙ).

In some examples, the character data 340 generated by the character animation model 330 indicate values (e.g., updated values) of one or more character attributes (e.g., gaze direction, pose, facial expression, etc.) in state Sₖ of the scene. The values of these character attributes can differ from their values in one or more prior states Sₖ₋₁, Sₖ₋₂, . . . , Sₖ₋ₙ of the scene. Thus, the visual representations of these character attributes can differ in a frame Fₖ depicting state Sₖ of the scene, relative to frames Fₖ₋₁, Fₖ₋₂, . . . , Fₖ₋ₙ depicting past states Sₖ₋₁, Sₖ₋₂, . . . , Sₖ₋ₙ of the scene.

Optionally, character data 340 can indicate predicted values of one or more character attributes (e.g., gaze direction, pose, facial expression, etc.) for one or more future states of the scene Sₖ₊₁, Sₖ₊₂, . . . , Sₖ₊ₘ. A set of predicted values of a character attribute is sometimes referred to herein as a “predicted trajectory”of the character attribute.

As described above, the features 325 extracted by the feature extractor 320 and provided as inputs to the character animation model 330 can include environmental features of the scene. In some examples, the features 325 include one or more emotional environmental features of the scene and/or one or more social environmental features of the scene. In some examples, the features 325 include at least two types of environmental features of the scene (e.g., physical and emotional environmental features, physical and social environmental features, or emotional and social environmental features). In some examples, the features 325 include at least one physical environmental feature, at least one emotional environmental feature, and at least one social environmental feature.

In some examples, the video animation engine 100 provides a ‘long’ feedback path from the output of the character animation model 330, through the feature extractor 320, to the input of the character animation model. When the long feedback path is used, the scene data 310 can include values of character attributes generated and/or predicted by the character animation model 330. For example, the scene data can include generated values and/or predicted trajectories of the gaze direction, pose, and/or facial expression attributes for one or more characters. In such cases, the feature extractor 320 can extract features 325 based on the character attribute values generated and/or predicted by the character animation model.

In addition or as an alternative to the ‘long’ feedback path, the video animation engine 100 can provides a ‘short’ feedback path from the output of the character animation model 330 to the input of the character animation model, bypassing the feature extractor 320.

When the short feedback path is used, the features 325 can include the character attribute values generated and/or predicted by the character animation model. For example, at least a portion of the character data 340 generated by the character animation model 330 can be fed back to the input of the character animation model 330 as a subset of the features 325. In some examples, using the short feedback path helps the character animation model 330 rapidly account for recently generated (or predicted) values of character attributes when generating (or predicting) values of the same or other character attributes.

In some examples, the character animation model 330 includes one or more artificial intelligence (AI) models, which generate(s) the character data 340 based on the features 325. Any suitable type of AI model can be used, including predictive models, generative AI (“Gen AI”) models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

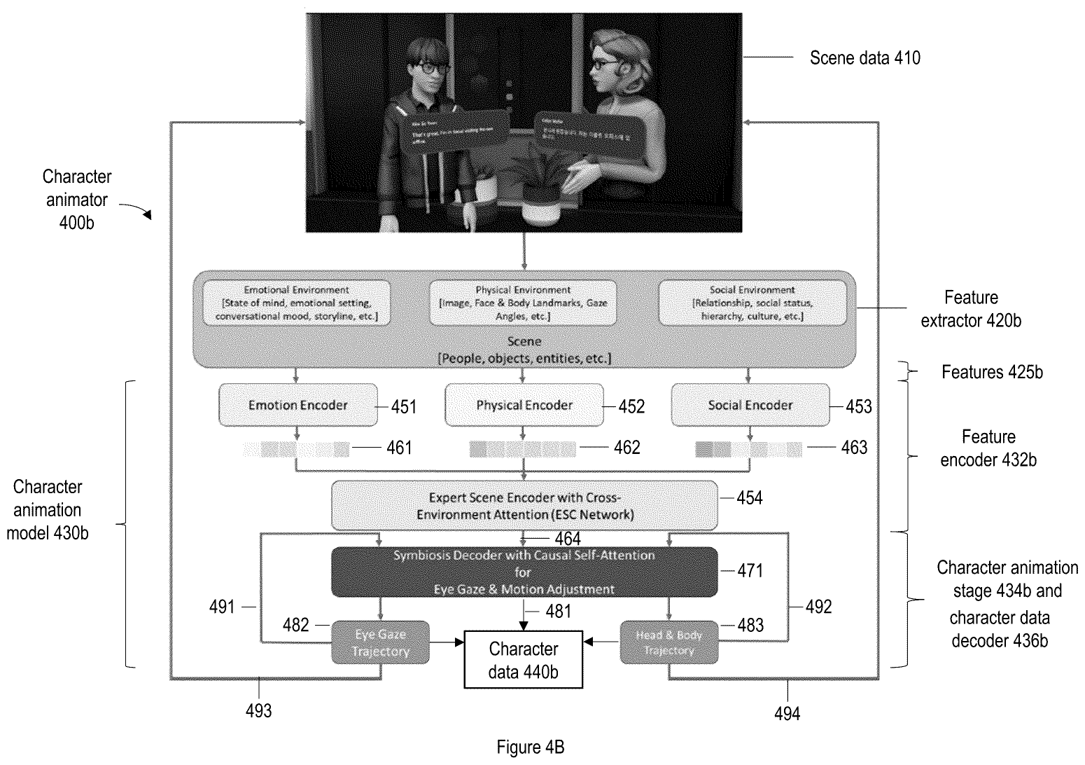

Generative AI models can analyze existing content, identify patterns in the content, and combine or modify the identified patterns to generate new content. The new content can include text, images, video, music, or any other suitable type of content. Some non-limiting examples of generative AI models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc. Some specific examples of model architectures for the character animation model 330 are described herein with reference to FIGS. 4A and 4B.

In some examples, the character animator 300 is a trained AI model. Any suitable techniques, including supervised, unsupervised, and semi-supervised techniques can be used to train the AI model. In some examples, training the AI model involves obtaining a character animation dataset, fitting the AI model to a training portion of the character animation dataset (“training data”), validating the AI model on a validation portion of the character animation dataset (“validation data”), and testing the AI model on a testing portion of the character animation dataset (“testing data”). The character animation dataset can include input samples of scene data 310 (the inputs to the character animator 300), and corresponding output samples of output data (e.g., character data 340, state data 107b, frames 135, video 145, and/or raw video data extracted from the frames/video). In some examples, the output samples indicate ground-truth values of the output data (e.g., values of the output data deemed correct or acceptable by a suitable authority).

Fitting the AI model to the training data can involve adjusting values of parameters of the AI model (e.g., parameter values of the feature extractor 320 and/or the character animation model 330) such that the AI model learns the relationship between the input and output samples of the training portion of the dataset. Validating the AI model on the validation data can involve using the AI model to generate output samples corresponding to the input samples of the validation data and assessing the AI model's performance based on a comparison of the model-generated output samples and the corresponding ground-truth output samples. In some examples, the training and validation steps are performed iteratively until the AI model exhibits an acceptable level of performance. Testing the AI model on the testing data can involve using the AI model to generate output samples corresponding to the input samples of the testing dataset, where the input samples of the testing dataset have not been used during the training and validation steps.

In some examples, training the AI model can further include fine-tuning the AI model for a particular application (e.g., application 105). Fine-tuning the model can involve performing the training process again, using a character animation dataset specific to the particular application, with a subset of the AI model's parameters frozen (not permitted to change values) and another subset of the AI model's parameters unfrozen (permitted to change values).

As described above, the input samples of the training data can include frames, video, and/or raw video data depicting prior states of a scene, and the output samples of the training data can include frames, video, and/or raw video data depicting the next state of the scene. The use of such input and output samples can facilitate unsupervised training of the AI model. In some examples, using unsupervised training techniques, the AI model can be trained on existing videos in which the gaze directions, poses, and/or facial expressions of the characters depicted in the videos are natural and realistic. For example, the AI model can be trained on videos of animated movies or shows (or even live-action movies or shows) produced by reputable studios, which often use labor-intensive production techniques to ensure that gaze directions, poses, and/or facial expressions are natural and realistic.

In contrast, when the input samples of the training data include state data 107a representing attribute values generated by a scene model, and the output samples of the training data include state data 107b representing attribute values generated by the AI model, unsupervised training techniques may be infeasible or impractical. In such cases, supervised training techniques can be used. In some examples, unsupervised or semi-supervised training techniques with datasets including frames / videos / raw video data can be used to train the AI model, and supervised training techniques with datasets including state data 107a/107b can be used to fine-tune the trained AI model for particular applications.

Referring to FIG. 4A, a block diagram of an example of a character animator 400a (e.g., character animator 300) is shown. In some examples, the character animator 400a includes a feature extractor 420a (e.g., feature extractor 320) and a character animation model 430a (e.g., character animation model 330). In some examples, the feature extractor 420a extracts features 425a (e.g., features 325) from scene data 410 (e.g., scene data 310) and provides the extracted features as inputs to the character animation model 430a, which generates character data 440a (e.g., character data 340) based on the features 425a. In other examples, the feature extractor 420a is omitted, such that the unaltered scene data 410 are provided to the character animation model 430a as features 425a.

In some examples, the character animation model 430a has an encoder-decoder architecture. In some examples, the character animation model includes a feature encoder 432a, a character animation stage 434a, and a character data decoder 436a. The feature encoder can process the features 425a (e.g., environmental features) to generate encoded features 433a (e.g., encoded environmental features). The character animation stage 434a can process the encoded features 433a to generate encoded animation data 435a. The character data decoder 436a can process the encoded animation data 435a to generate the character data 440a. The components of the character animation model 430a are described in further detail below.

In some examples, the feature encoder 432a generates distinct encoded features 433a corresponding to distinct aspects of the environment associated with the scene. For example, the feature encoder 432a can generate encoded physical features relating to the physical environment of the scene, encoded social features relating to the social environment of the scene, encoded emotional features relating to the emotional environment of the scene, etc.

In some examples, the feature encoder 432a includes a contrastive encoder. In some examples, the encoded features 433a generated by the contrastive encoder are embedding vectors (“embeddings”), which the feature encoder 432a embeds in a latent space such that the embeddings for similar scene data 410 are positioned close to each other within the latent space. In some examples, the feature encoder 432a generates distinct embeddings for distinct aspects of the scene's environment (e.g., the physical, social, and emotional aspects of the environment), such that the embeddings of the distinct aspects of the environment are mapped to distinct latent spaces. This use of distinct latent embedding spaces can help the character animation model 430a to learn the relationships among and relative importance of various portions of the scene data 410 that convey information about each aspect of the environment. When distinct embedding spaces (e.g., latent embedding spaces) are provided for the embeddings of distinct aspects of the environment, the feature encoder 432a can, in some examples, fuse the distinct embeddings of the environment's aspects (e.g., physical, social, and emotional embeddings) to generate a joint environmental embedding that represents the decisive attributes of the scene (e.g., the attributes of the scene that have the greatest impact on the animation of character attributes) in a joint latent embedding space. This use of a fused latent embedding space can help the character animation model 430a learn the relationships among the regions of the distinct embedding spaces, which can convey complex and subtle interdependences between the different aspects (e.g., physical, social, and emotional) of an environment. Likewise, this use of a fused latent embedding space can help the character animation model 430a learn the relative importance and joint impact of the different aspects of an environment on the characters'animation (e.g., the next states of their gaze direction, pose, and/or facial expression attributes).

An example has been described in which the feature encoder 432a includes a contrastive encoder, but any suitable encoder can be used. In some examples, the feature encoder 432a generates descriptors (e.g., labels, classifications, etc.) describing the environment(s) of the scene. Such descriptors can be used in addition to or as alternatives to the above-described embeddings.

In some examples, the character animation stage 434a of the character animation model 430a includes a neural network (e.g., CNN, RNN, attention-based NN, etc.), transformer, or any other suitable model. The use of an attention-based model can help the character animation stage 434a assess the relative importance of interdependent physical attributes of a character (e.g., gaze direction, pose, facial expression, etc.) to the realism or naturalness of the character animation being generated by the model. In other words, an attention-based mechanism can help the character animation stage 434a determine which physical attribute of the character is more dominant in the character's response to the environment. In some situations, the realism or naturalness of a character's animation can depend more strongly on establishing a particular gaze direction, in which case the attention-based model can prioritize the character's gaze direction and adjust the character's pose to accommodate that gaze direction. In other situations, the realism or naturalness of a character's animation can depend more strongly on establishing a particular pose, in which case the attention-based model can prioritize the character's pose (or body motion) and adjust the character's gaze direction to accommodate the character's pose.

The character animation stage can use any suitable attention mechanism(s) including, without limitation, self-attention (e.g., causal self-attention, linearized self-attention, etc.), additive attention (e.g., Bahdanau-style attention), multiplicative attention (e.g., Luong-style attention), channel attention, spatial attention, multi-head attention, soft attention, hard attention, global attention, local attention, etc. In some examples, the neural network of the character animation stage 434a uses a causal self-attention mechanism.

In some examples, the character animation stage 434a of the character animation model 430a includes an autoregressive model (e.g., an autoregressive neural network with a causal self-attention mechanism). In some examples, the autoregressive model not only generates attribute values for a character in state Sₖ of a scene, but also predicts future values (trajectories) of attributes (e.g., gaze direction, pose, facial expression, etc.) for the character in states Sₖ₊₁, Sₖ₊₂, . . . Sₖ₊ₘ of the scene, where m is any suitable integer.

In some examples, the trajectories of the character attributes predicted by the character animation stage 434a are fed back to the input of the character animation stage 434a.

Such feedback can be provided using a ‘short’ feedback path (e.g., the encoded values of the predicted trajectories can be included in the encoded features 433a provided as input to the character animation stage 434a) and/or a ‘long’ feedback path (e.g., the decoded values of the predicted trajectories provided by the character data decoder 436a can be included in the scene data 410 and/or in the features 425a provided as input to the feature encoder 432a).

Thus, in some examples, the character animation model 430a generates a sequence of values for character attributes (e.g., eye gaze, pose, facial expression, etc.) based on scene data 410 (e.g., previous states and/or frames of a scene, trajectories of the character attributes in previous states and/or frames of the scene, etc.), a joint environment embedding that encodes physical, social, and/or emotional attributes of the scene, and predicted trajectories of the values of the character attributes in future states and/or frames of the scene. In this way, the character animation model 430a can generate animations of the characters'attributes (e.g., eye gaze, pose, facial expression, etc.) in which those attributes are symbiotically related to each other and also based on the characters'environment.

Still referring to FIG. 4A, the character data decoder 436a produces character data 440a by decoding the encoded animation data 435a generated by the character animation stage 434a. Any suitable decoder architecture and decoding techniques can be used. In some examples, the character data 440a indicate values (e.g., updated values) of one or more character attributes (e.g., gaze direction, pose, facial expression, etc.) in state Sₖ of the scene. In some examples, the character data 440a indicate predicted trajectories of the character attributes.

Referring to FIG. 4B, a block diagram of another example of a character animator 400b (e.g., character animator 300) is shown. In some examples, the character animator 400b includes a feature extractor 420b (e.g., feature extractor 320) and a character animation model 430b (e.g., character animation model 330). In some examples, the feature extractor 420b extracts features 425b (e.g., features 325) from scene data 410 (e.g., scene data 310) and provides the extracted features as inputs to the character animation model 430b, which generates character data 440b (e.g., character data 340) based on the features 425b. In other examples, the feature extractor 420b is omitted, such that the unaltered scene data 410 are provided to the character animation model 430b as features 425b.

In some examples, the feature encoder 432b is a contrastive encoder. In some examples, the feature encoder 432b includes distinct encoders (e.g., “channel encoders”) for distinct aspects of the scene's environment (e.g., “channels”). For example, the feature encoder 432b can include a first encoder 451 that encodes an emotional environment of the scene as an embedding 461 in a latent embedding space corresponding to the emotional environment, a second encoder 452 that encodes a physical environment of the scene as an embedding 462 in a latent embedding space corresponding to the physical environment, and a third encoder 453 that encodes a social environment of the scene as an embedding 463 in a latent embedding space corresponding to the social environment.

In some examples, the physical environment of a scene can change more rapidly than the social and/or emotional environments of the scene. For example, the physical environment of the scene can change between each pair of adjacent frames in a lengthy sequence of frames, while the social and/or emotional environments can remain unchanged or nearly unchanged throughout the entire sequence of frames. Thus, in some examples, the scene data 410 can be updated with new data relating to the physical environment of the scene at a first rate (e.g., once per frame) and updated with new data relating to the social and/or emotional environments of the scene at a second, slower rate (e.g., once every N_{F} frames or every N_{S} seconds, where N_{F} is any suitable integer greater than 1 and N_{S} is any suitable positive number). Additionally or alternatively, the encoder 452 for the physical environment of the scene can be activated at a first rate, and the encoders (451, 453) for the emotional and/or social environments of the scene can be activated at a second, slower rate, irrespective of how rapidly the scene data 410 are updated. Both approaches can have the benefit of improving the computational efficiency of the character animator 400b without significantly degrading the quality of the character animations it generates.

In some examples, the feature encoder 432b further includes a fourth encoder 454 that generates a joint embedding 464 in a latent embedding space corresponding to the joint emotional, physical, and social environments of the scene. The fourth encoder 454 can generate the joint embedding 464 by processing (e.g., fusing) the first, second, and third embeddings (461-463). In some examples, the fourth encoder 454 uses a cross-channel attention mechanism to learn relationships and interactions between the distinct embeddings 461-463 (or embedding spaces) of the emotional, social, and physical environments. The feature encoder 432b can provide the joint embedding 464 as input to the character animation stage 434b.

In some examples, the character animation stage 434b and the character data decoder 436b are integrated into a neural network 471 with a causal self-attention mechanism. In some examples, the neural network 471 is autoregressive. The autoregressive neural network can generate values 481 of attributes (e.g., gaze direction, pose, facial expression, etc.) for a character in state Sₖ of a scene and predict future values (trajectories 482, 483) of those attributes for the character in states Sₖ₊₁, Sₖ₊₂, . . . Sₖ₊ₘ of the scene, where m is any suitable integer. The character data 440b generated by the character animator 400b can include the generated attribute values 481 and predicted trajectories 482, 483. In some examples, the trajectories of the character attributes predicted by the neural network 471 are fed back to the input of the neural network 471 using a short feedback path 491 or 492 and/or fed back to the input of the character animator 400b (e.g., as part of the scene data 410) using a long feedback path 493 or 494.

Thus, in some examples, the character animation model 430b generates a sequence of values for character attributes (e.g., eye gaze, pose, facial expression, etc.) based on scene data 410 (e.g., previous states and/or frames of a scene, trajectories of the character attributes in previous states and/or frames of the scene, etc.), a joint environment embedding 464 that encodes physical, social, and/or emotional attributes of the scene, and predicted trajectories (482, 483) of the values of the character attributes in future states and/or frames of the scene. In this way, the character animation model 430b can generate animations of the characters'attributes (e.g., eye gaze, pose, facial expression, etc.) in which those attributes are symbiotically related to each other and also based on the characters'environment.

FIG. 5 is a flow diagram of an example computer-implemented video animation method 500. In some examples, performing the video animation method 500 generates a video of one or more animated characters. The video animation method 500 can be performed, for example, by the video animation engine 100. In some examples, the method 500 includes a step 510 of generating a first frame depicting a first state of a scene, where the first frame includes avatar(s) representing character(s) and each avatar has a first gaze direction and/or pose; a step 520 of generating second gaze directions and/or poses of the characters in a second state of the scene based on environmental features of the first state of the scene; a step 530 of generating a second frame depicting the second state of the scene, with the avatars having the second gaze directions and/or poses; and a step 540 of outputting the first and second frames. Some examples of the steps of the video animation method 500 are described in further detail below.

In some examples, performing the video animation method 500 generates an animated video including a sequence of frames depicting a sequence of states of a scene. The scene can include one or more characters, and the frames can include avatars of the characters. The video animation method 500 can include steps 510-540.

In step 510, a first frame in the sequence of frames can be generated. The first frame can depict a first state of the scene. The first frame can include a first avatar representing a first character and having a first gaze direction and/or pose in the first state.

In step 520, character data can be generated. The character data can indicate a second gaze direction and/or pose of the first character in a second state. The character data can be generated based on one or more environmental features of the scene (e.g., of the first state of the scene and/or states prior to the first state of the scene). Additionally or alternatively, the character data can be generated based on the character's gaze direction and/or pose in one or more prior states or frames of the scene (e.g., the first state or frame). In some examples, the character data are generated based on predicted trajectories of the character's gaze direction and/or pose (e.g., predicted trajectories of the character's gaze direction and/or pose in states of the scene subsequent to the second state).

The one or more environmental feature(s) can include one or more physical, emotional, and/or social environmental feature(s) of the scene. In some examples, the one or more environmental features include at least one social environmental feature and/or at least one emotional environmental feature. In some examples, the one or more environmental features include at least two different types of environmental features (e.g., physical and environmental features, physical and social features, or social and environmental features. In some examples, the one or more environmental features are all physical features.

In some examples, the character data are generated by a character animator 300. In some examples, generating the character data includes extracting (e.g., by a feature extractor 320 of the character animator), the one or more environmental features of the first state of the scene. In some examples, the environmental features are extracted from a model of the scene and/or from one or more frames of the scene (e.g., the first frame).

In some examples, the character data are generated by a character animation model 330 of the character animator 300. In some examples, generating the character data includes encoding (e.g., by a feature encoder of the character animation model) the one or more environmental features, thereby generating encoded features. In some examples, generating the character data includes generating (e.g., by a character animation stage of the character animation model) encoded animation data based on the encoded features. In some examples, generating the character data includes decoding (e.g., by a character data decoder) the encoded animation data to generate decoded animation data including the character data. In some examples, at least a portion of the decoded animation data are fed back from an output of the character data decoder to an input of the character animation stage.

In some examples, a first encoder 452 of the feature encoder encodes physical features of the scene in a first latent embedding space, a second encoder 451 of the feature encoder encodes emotional features of the scene in a second latent embedding space, and a third encoder 453 encoders social features of the scene in a third latent embedding space. In some examples, a fourth encoder 454 of the feature encoder fuses the encodings of physical, emotional, and social features into a joint encoding and embeds the joint encoding in a fourth latent embedding space. Alternatively, the physical features of the scene can be encoded in a first latent embedding space, and the social and emotional features of the scene can be encoded in a second, joint latent embedding space, and the encodings of the physical and social / emotional features can be fused and embedded in a joint, latent embedding space.

In step 530, a second frame in the sequence of frames can be generated. The second frame can depict the second state of the scene. In the second frame, the first avatar can have the second gaze direction and/or pose.

Step 540 can include providing (e.g., outputting) the first and second frames. In some examples, the first and second frames are provided sequentially. In some examples, the first and second frames are provided in parallel.

Some examples have been described in which the video animation method 500 generates animations of a character's gaze direction and/or pose. As noted above, the character's pose can include the orientation or posture of the character's head, body, or body parts. For example, the character's pose can include the orientation of the head (e.g., tilting the head to a side, up, or down); the orientation of the shoulders, and/or torso; the orientation of the feet (e.g., toward a speaking character); the position of the arms (e.g., folded across the chest, at the character's sides, etc.); etc. However, examples of the video animation method 500 are not limited to generating animations of a character's gaze direction and/or pose. In addition or as an alternative to generating a character's gaze direction and/or pose, the method 500 can be used to generate animations of a character's facial expression or any suitable attribute relating to the character's body language including breathing patterns (e.g., holding breath, breathing deeply, taking rapid and shallow breaths, etc.); nodding or shaking the head; gesticulating; relaxing or tensing muscles; etc.

Some examples of video animation techniques have been described. In some examples, applying the video animation techniques disclosed herein can (1) orient the eye gazes and/or poses of one or more characters in a scene towards a character who is speaking, (2) orient the eye gazes and/or poses toward areas in the scene where other events are occurring, (3) adjust the eye gazes, poses, facial expressions, and/or body language of one or more characters in a scene to reflect the scene's environment (e.g., physical, emotional, and/or social aspects of the scene's environment), (4) cause the eye gazes and poses of one or more characters in a scene to continually track the position of another character who is speaking and moving, (5) adjust the eye gaze of a character in response to a change in the character's pose (e.g., when the character is engaged in conversation with another character), and/or (6) adjust the pose of a character in response to a change in the character's eye gaze (e.g., when the character is engaged in conversation with another character). In some examples (e.g., when a scene includes three or more characters engaged in conversation), applying the video animation techniques disclosed herein can cause one or more characters to orient their eye gazes and poses toward a first character when a second character mentions the first character. In some examples, applying the video animation techniques disclosed herein can adjust the eye gazes and/or poses of one or more characters in a scene to account for the heights of the characters (e.g., tilt a character's face up and orient the character's gaze direction upward when talking to a taller character).

Some examples of applications of video animation techniques have been described. In some examples, the video animation techniques disclosed herein can be performed by a video animator that operates in concert with (e.g., “plugs into”) a pre-existing video animation engine. For example, such a video animator can adjust (e.g., overwrite) one or more attribute values generated by the pre-existing video animation engine (e.g., character gaze direction and/or pose), and the pre-existing video animation engine can perform other video animation tasks. In some examples, the video animation techniques disclosed herein can be (1) integrated into a video game engine (e.g., Unreal Engine, Unreal Engine's MetaHumans application, any version of the Skinned Multi-Person Linear Model (SMPL-X), etc.), (2) used to animate an interactive assistant (e.g., virtual salesperson capable of conversing with a user), (3) integrated into a video teleconferencing application (e.g., to animate avatars of users interacting in a virtual meeting room), (4) integrated into metaverse software (e.g., to animate avatars of interactive and autonomous digital store assistants who interact with other digital entities including digital humans, agents, etc.), etc.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above is a flow chart showing steps and acts of processes that generate animated video. The processing and decision blocks of the flow charts above represent steps and acts that can be included in algorithms that carry out these processes. Algorithms derived from these processes can be implemented as software integrated with and directing the operation of one or more single-or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flow chart(s) included herein do not depict the syntax or operation of any particular circuit or of any particular programming language or type of programming language. Rather, the flow chart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types.

Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application, for example as a software program application such as animator 120, video animation engine 100, or application 105. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

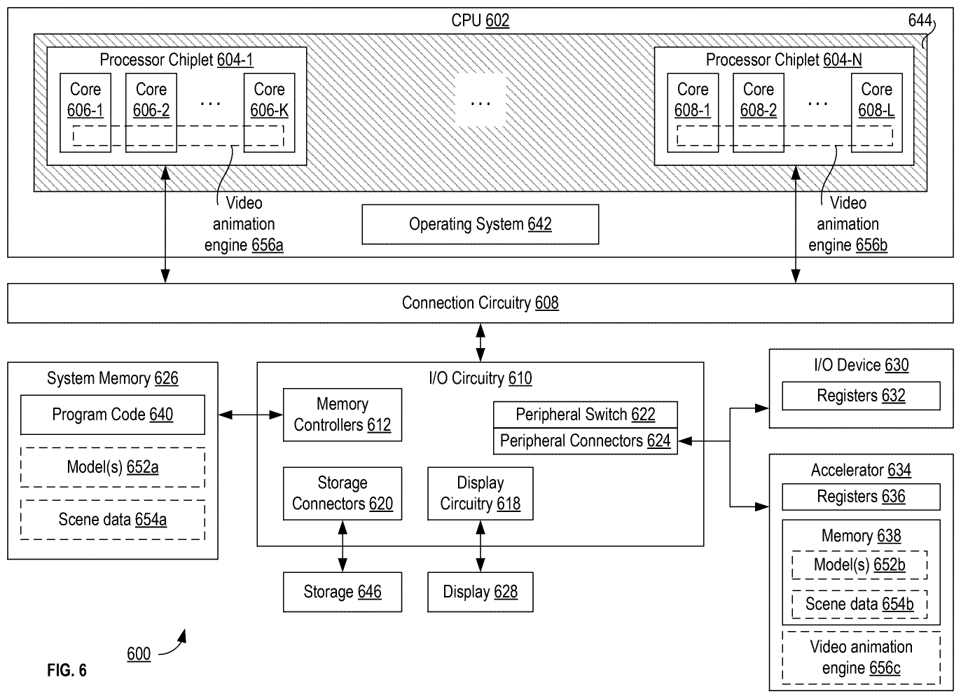

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 626, accelerator memory 638, and/or storage 646 of FIG. 6 described below (i.e., as a portion of a video animation system 600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques-such as implementations where the techniques are implemented as computer-executable instructions-the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 6 illustrates one exemplary implementation of a video animation system 600 configured to implement the techniques described herein, although others are possible. It should be appreciated that FIG. 6 is intended neither to be a depiction of necessary components for a video animation system 600 to operate in accordance with the principles described herein, nor a comprehensive depiction.

Video animation system 600 can be, for example, a desktop or laptop personal computer, a video game console, a personal digital assistant (PDA), a smart mobile phone, a server, a wireless access point or other networking element, or any other suitable computing system. Video animation system 600 can comprise at least one central processing unit (CPU) 602, connection circuitry 608, I/O circuitry 610, system memory 626, at least one I/O device 630, at least one accelerator 634, storage 646 (e.g., computer-readable storage media), and/or at least one display 628.

CPU 602 enables processing of data and execution of instructions. The data and instructions can be stored on system memory 626, storage 646, and/or internal memory (not shown) of the CPU 602. In some examples, the CPU 602 includes one or more processor chiplets 604-1 . . . 604-N, which may be disposed on or over a package substrate 644. In some examples, the processor chiplets 604 can communicate with each other via interconnects routed through or on the package substrate 644 (e.g., through an interposer layer disposed between the package substrate 644 and the processor chiplets 604). In some examples, each processor chiplet 604 includes one or more cores (606, 608). Different processor chiplets 604 can have the same or different numbers of cores (606, 608). In the example of FIG. 6, processor chiplet 604-1 has K cores 606-1, 606-2, . . . 606-K, and processor chiplet 604-N has L cores (608-1, 608-2, . . . 608-L). The cores within an individual processor chiplet (e.g., cores 606-1, 606-2, . . . 606-K) can be homogeneous or heterogeneous. Likewise, the cores on different processor chiplets (e.g., cores 606-1 and 608-1) can be homogeneous or heterogeneous.

In the example of FIG. 6, the CPU 602 is configured to execute instructions of an operating system 642 and/or instructions (e.g., program code 640) of one or more applications. In some examples, the CPU 602 is configured to execute instructions of a video animation engine (e.g., video animation engine 100). In some examples, the functionality of a video animation engine may be implemented by one or more CPUs 602, one or more processor chiplets of a CPU 602, and/or one or more cores of a processor chiplet. In the example of the FIG. 6, instructions of a portion of the video animation engine 656a are executed by the cores of processor chiplet 604-1, and instructions of another portion of the video animation engine 656b are executed by the cores of processor chiplet 604-N. In other implementations, the CPU 602 can execute the video animation engine, in cooperation with the accelerator 634, which can assist in executing other portions through the use of shader software and/or fixed function hardware.

The data and instructions stored on any of the computer-readable storage media (e.g., system memory 626, storage 646, accelerator memory 638, internal or external caches of the CPU 602, etc.) can comprise computer-executable instructions implementing techniques which operate according to the principles described herein. In the example of FIG. 6, system memory 626 stores computer-executable instructions implementing various facilities as described above (e.g., animators, renderers, video generators, video animation engines, character animators, feature extractors, encoders, decoders, etc.). In the example of FIG. 6, system memory 626 may store one or more models 652a (e.g., scene models, character animation models, etc.) and/or scene data 654a, in whole or in part. Additionally or alternatively, accelerator memory 638 may store one or more models 652b (e.g., scene models, character animation models, etc.) and/or scene data 654b, in whole or in part.

In some examples, connection circuitry 608 communicatively couples CPUs 602 with each other and/or with external caches (e.g., level-2 (L2) cache, level-3 (L3) cache, etc.).

Additionally or alternatively, the connection circuitry 608 can communicatively couple the CPUs 602 with I/O circuitry 610, which communicatively couples system memory, storage devices, and peripheral devices to each other and (via the connection circuitry 608) to the CPUs 602. The connection circuitry can couple the CPUs 602, external caches, and I/O circuitry 610 using any suitable network topology (e.g., a front-side bus, a back-side bus, etc.), and the coupled components can send and receive messages via the connection circuitry using any suitable communication protocol. In some examples, portions of the connection circuitry 608 can be integrated into the CPUs 602.

In some examples, I/O circuitry 610 includes one or more memory controllers 612, one or more storage connectors 620, display circuitry 618, one or more peripheral connectors 624, and a peripheral switch 622. The memory controller(s) 612 can be configured to control the flow of data to and from the system memory 626. The storage connector(s) 620 can be configured to control the flow of data to and from the storage 646. The display circuitry 618 can be configured to send visual data (e.g., user interface data, image data, video data, etc.) to the display 628, which can be configured to display the visual data. In some examples, the display circuitry 618 can also be configured to receive data representing user input from the display 628 (e.g., in cases where the display 628 includes a touchscreen). In some examples, portions of the I/O circuitry 610 can be integrated into a motherboard and/or motherboard chipset of the video animation system 600.

Each of the peripheral connectors 624 may be configured to physically connect and communicatively couple the I/O circuitry 610 to a peripheral device. Any suitable type of peripheral device can be connected to a peripheral connector 624 including, without limitation, an I/O device 630 (e.g., an input device, output device, or input / output device), an accelerator, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the video animation system 600 to communicate wired and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 632. In some examples, the I/O circuitry 610 can control the operation of an I/O device 630 by writing suitable data to one or more of the I/O device's registers, and/or can monitor the status of an I/O device 630 by reading the contents of one or more of the I/O device's registers.

Some non-limiting examples of an accelerator 634 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 634 includes one or more registers 636 and memory 638. In some examples, the I/O circuitry 610 can control the operation of an accelerator 634 by writing suitable data to one or more of the accelerator's registers, and/or can monitor the status of an accelerator 634 by reading the contents of one or more of the accelerator's registers. In some examples, an accelerator's memory 638 may store data or one or more models of the video animation system 600. In the example of FIG. 6, accelerator memory 638 may store one or more models 652b (e.g., scene models, character animation models, etc.) and/or scene data 654b, in whole or in part. In some examples, instructions of at least a portion of the video animation engine 656c are executed by an accelerator 634. In alternative implementations, at least portions of the video animation engine 656c can be implemented as circuitry of the accelerator 634. For example, renderer 130 can be implemented as a rendering pipeline of a GPU, whereas the video generator 140 can be implemented using the rasterization pipeline of a GPU. In such implementations, the accelerator 634 can receive instructions from the CPU 602, through drivers, and set up appropriate pipelines, using shader software and/or fixed function hardware to implement the video animation engine 656.

The peripheral switch 622 can be configured to switch packets sent to or from the peripheral devices. Any suitable type of peripheral connector(s) 624 and peripheral switch 622 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above video animation system 600 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A video animation system comprising:
at least one processor; and
at least one computer-readable storage medium having encoded thereon instructions that, when executed by the at least one processor, cause the at least one processor to perform operations including:
generating a first frame of a video including a first avatar wherein the first avatar has a first gaze direction and/or a first pose;
generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and
outputting the first and second frames.

2. The system of claim 1, wherein the at least one processor includes at least one graphics processing unit (GPU).

3. The system of claim 1, wherein the video includes a sequence of frames depicting a sequence of respective states of a scene, the scene including one or more characters, the sequence of frames including one or more respective avatars of the one or more characters.

4. The system of claim 3, wherein the sequence of frames includes the first frame and the second frame, wherein the first frame depicts a first state of the sequence of states of the scene, and wherein the second frame depicts a second state of the sequence of states of the scene.

5. The system of claim 4, wherein the operations further include generating the video, and wherein generating the video includes:
the generating the first frame;
generating, using at least one model, character data indicating the second gaze direction and/or the second pose of the first character in the second state of the scene, the generating the character data being based on the plurality of environmental features of the first frame; and
the generating the second frame,
wherein the plurality of environmental features of the first frame correspond to the first state of the scene.

6. The system of claim 5, wherein the at least one processor includes a first processor configured to perform the generating the first frame and the generating the second frame, and a second processor configured to perform the generating the character data.

7. The system of claim 5, wherein the generating the character data using the at least one model is further based on the first gaze direction and/or the first pose of the first avatar in the first frame, and wherein the at least one model includes at least one character animation model.

8. The system of claim 5, wherein the generating the character data using the at least one model is further based on one or more predicted gaze directions and/or one or more predicted poses of the first avatar for one or more frames subsequent to the second frame, and wherein the at least one model includes at least one character animation model.

9. The system of claim 4, wherein the plurality of environmental features of the first frame include one or more physical environmental features of the first state of the scene, and wherein the one or more physical environmental features of the first state of the scene include one or more attributes of the one or more characters in the first state of the scene, wherein the one or more attributes of a particular character of the one or more characters include a location of the particular character, a location of a facial landmark or body landmark of the particular character, a gaze direction of the particular character, and/or a pose of the particular character.

10. The system of claim 3, wherein the one or more emotional environmental features of the first frame include one or more emotional states of the one or more characters, a mood of a conversation between two or more of the characters, and/or an emotional context associated with the scene.

11. The system of claim 3, wherein the one or more social features of the first frame include one or more social statuses of the one or more characters, one or more social or hierarchical relationships between or among the one or more characters, and/or a cultural context associated with the one or more characters.

12. The system of claim 1, wherein the video depicts at least a portion of a video game, movie, show, videoconference, virtual reality (VR) application, augmented reality (AR) application, metaverse, or digital assistant.

13. A video animation method, comprising:
generating, by at least one processor, a first frame of a video including a first avatar wherein the first avatar has a first gaze direction and/or a first pose;
generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and
outputting the first and second frames.

14. The video animation method of claim 13, wherein the video includes a sequence of frames depicting a sequence of respective states of a scene, the scene including one or more characters, the sequence of frames including one or more respective avatars of the one or more characters, wherein the sequence of frames includes the first frame and the second frame, wherein the first and second frames depict first and second states of the sequence of states of the scene, respectively.

15. The video animation method of claim 14, wherein the plurality of environmental features of the first frame include at least two of a physical environmental feature of the first state of the scene, an emotional environmental feature of the first state of the scene, or a social environmental feature of the first state of the scene.

16. The video animation method of claim 13, further comprising generating character data indicating the second gaze direction and/or the second pose of the first avatar in the second frame, the generating the character data being based on a plurality of environmental features of the first frame.

17. The video animation method of claim 16, wherein the first avatar has, in the first frame, a first facial expression, wherein the character data further indicate a second facial expression of the character, and wherein the first avatar has, in the second frame, the second facial expression.

18. The video animation method of claim 16, wherein the generating the character data is further based on the first gaze direction, the first pose of the first avatar in the first frame, one or more predicted gaze directions of the first avatar for one or more frames subsequent to the second frame, and/or one or more predicted poses of the first avatar for one or more frames subsequent to the second frame.

19. The video animation method of claim 14, wherein the plurality of environmental features of the first frame include one or more physical environmental features of the first state of the scene, and wherein the one or more physical environmental features of the first state of the scene include:
one or more attributes of one or more objects, entities, and/or settings in the first state of the scene, and/or
one or more attributes of the one or more characters in the first state of the scene, wherein the one or more attributes of a particular character of the one or more characters include a location of the particular character, a location of a facial landmark or body landmark of the particular character, a gaze direction of the particular character, and/or a pose of the particular character.

20. At least one computer-readable storage medium encoded with computer-executable instructions that, when executed by at least one computer, cause the at least one computer to perform operations including:
generating a first frame a video including a first avatar wherein the first avatar has a first gaze direction and/or a first pose;
generating a second frame of the video, wherein the first avatar has a second gaze direction and/or a second pose, wherein the second gaze direction and/or second pose is based on a plurality of environmental features of the first frame, the environmental features including one or more emotional environmental features of the first frame and/or one or more social environmental features of the first frame; and outputting the first and second frames.
